(19) United States
(12) Patent Application Publication
(10) Pub. No.: US 2014/0014443 A1
(43) Pub. Date: Jan. 16, 2014

(54) HOIST

(71) Applicant: Keiichi Koroki, Tokyo (JP)

(72) Inventor: Keiichi Koroki, Tokyo (JP)

(21) Appl. No.: 13/878,897

(22) PCT Filed: Oct. 13, 2011
(86) PCT No.: PCT/JP2011/073479

§ 371 Date: Sep. 30, 2013

(30) Foreign Application Priority Data
Oct. 15, 2010 (JP) 2010-232145

(51) Int. Cl. B66B 11/04; B66B 5/00

(52) U.S. Cl. CPC B66B 11/0438; B66B 5/00
USPC 187/276

(57) ABSTRACT

The purpose of the present invention is to provide a hoist that has a simple configuration while being capable of withstanding heavy loads. Accordingly, the hoist (1) is provided with: a sheave (10); a left stand (11) and a right stand (12) that rotatably support the sheave (10) at both ends in the axial direction; a rotor (4) installed on the end of the sheave (10) on the left stand (11) side; a stator (5) installed at a position facing the inner diameter side of the rotor (4); a brake disc (30) installed on the same axis as the sheave (10) on the end of the sheave (10) on the right stand (12) side; and a brake device (31) that is installed on the right stand (12), and that applies pressure to the brake disc (30) to provide braking.

### TECHNICAL FIELD

The present invention relates to a hoist.

### BACKGROUND ART

A hoist for use in an elevator and the like is conventionally known. For example, in a conventional hoist disclosed in Patent Document 1 below, a rotor is supported by a cantilever shaft, and when a sheave is put under a load, the cantilever shaft is curved. This makes the air-gap of the motor uneven and thus lowers the motor performance. Further, in a worst-case scenario, friction might occur in the air gap, making impossible for the motor to operate.

Accordingly, in the conventional hoist, the curving of the cantilever shaft caused by a load has to be reduced. In one method of reducing the curving of the cantilever shaft caused by a load, the diameter of the cantilever shaft is increased to reduce the curving.

### PRIOR ART DOCUMENT

### Patent Document

Patent Document 1: Japanese Patent Application Publication No. Hei 9-142761

### SUMMARY OF THE INVENTION

### Problems to be Solved by the Invention

The conventional hoist described above employs the method of increasing the diameter of the cantilever shaft to reduce the curving caused by a load.

However, in an extremely large hoist, the diameter of the cantilever shaft needs to be increased so much that it is difficult to adopt this method.

Moreover, when the cantilever shaft is large, a bearing and a frame supporting the cantilever shaft also have to be large. Consequently, the hoist becomes very large and heavy.

In addition to the above problem, such a hoist has a problem of requiring high costs.

In consideration of the above, the present invention has an objective of providing a hoist having a simple configuration yet capable of supporting a heavy load.

### Means for Solving the Problems

To solve the above problems, a hoist according to a first invention is characterized in that the hoist comprises: a sheave; first supporting means and second supporting means for supporting the sheave at both ends of the sheave in an axial direction thereof, respectively, such that the sheave is rotatable; a rotor placed on the end portion of the sheave on the first supporting means side; a stator placed at a position facing an inner side of the rotor; a brake disk placed on the end portion of the sheave on the second supporting means side coaxially with the sheave; and braking means for providing braking by applying a pressure to the brake disk, the braking means being placed on the second supporting means.

To solve the above problems, a hoist according to a second invention is the hoist according to the first invention and is characterized in that the hoist further comprises, between the first supporting means and the second supporting means, maintaining means for maintaining a gap between the first supporting means and the second supporting means.

To solve the above problems, a hoist according to a third invention is the hoist according to the first invention or the second invention and is characterized in that the hoist further comprises: a rotation detection shaft placed at an axial end of the sheave and penetrating the first supporting means; and rotation detecting means placed on the rotation detection shaft.

### Effect of the Invention

The present invention can provide a hoist having a simple configuration yet capable of supporting a heavy load.

### BRIEF DESCRIPTION OF THE DRAWINGS

FIG. 1 is a sectional view of a hoist according to a first embodiment of the present invention.

FIG. 2 is a side view of the hoist according to the first embodiment of the present invention.

FIG. 3 is a front view of the hoist according to the first embodiment of the present invention.

FIG. 4 is a rear view of the hoist according to the first embodiment of the present invention.

FIG. 5 is a sectional view of another example of the hoist according to the first embodiment of the present invention.

FIG. 6 is a sectional view of a hoist according to a second embodiment of the present invention.

FIG. 7 is a side view of the hoist according to the second embodiment of the present invention.

FIG. 8 is a front view of the hoist according to the second embodiment of the present invention.

FIG. 9 is a rear view of the hoist according to the second embodiment of the present invention.

FIG. 10 is a sectional view of another example of the hoist according to the second embodiment of the present invention.

FIG. 11 is a sectional view of a hoist according to a third embodiment of the present invention.

FIG. 12 is a side view of the hoist according to the third embodiment of the present invention.

FIG. 13 is a front view of the hoist according to the third embodiment of the present invention.

FIG. 14 is a rear view of the hoist according to the third embodiment of the present invention.

FIG. 15 is a sectional view of another example of the hoist according to the third embodiment of the present invention.

### MODES FOR CARRYING OUT THE INVENTION

With reference to the drawings, a description is given below of modes for carrying out a hoist according to the present invention.

### Embodiment 1

A first embodiment of the hoist according to the present invention is described below.

First, the configuration of the hoist according to this embodiment is described.

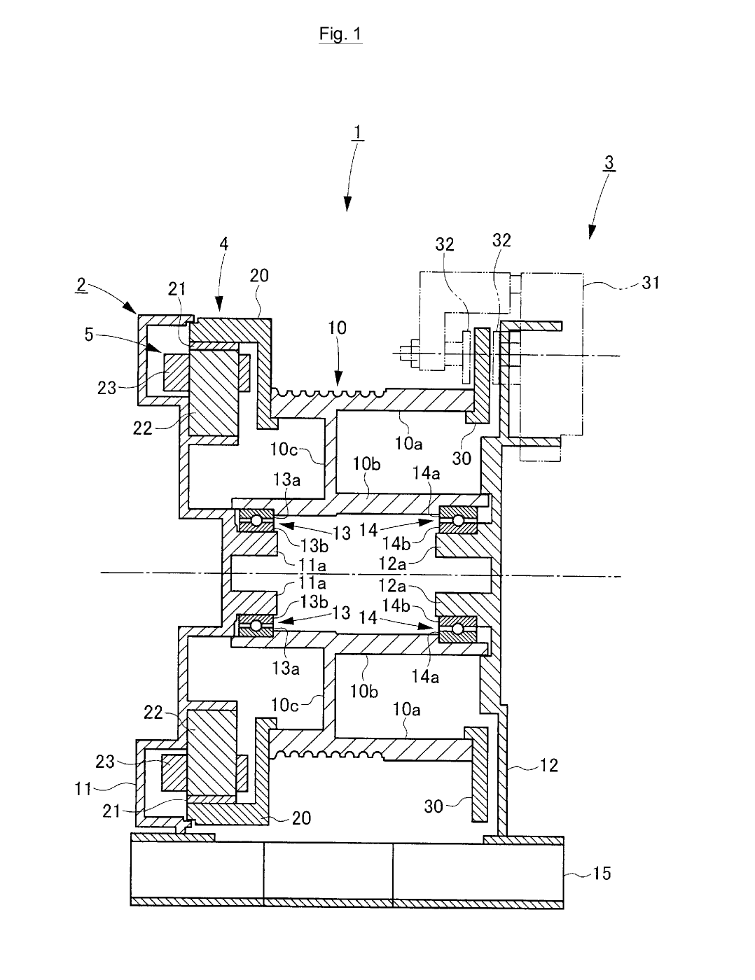

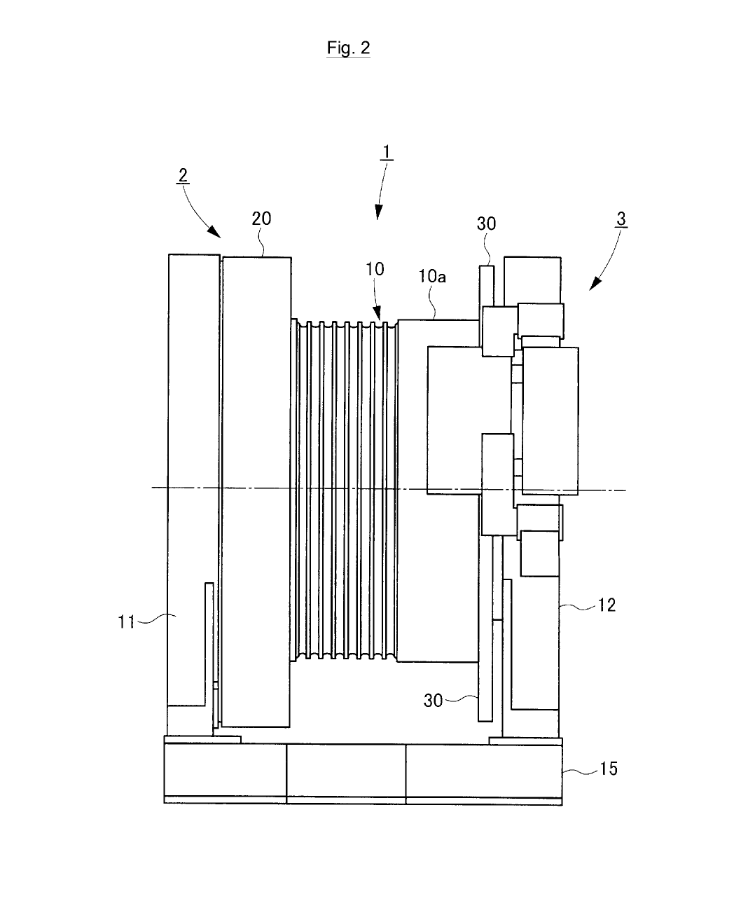

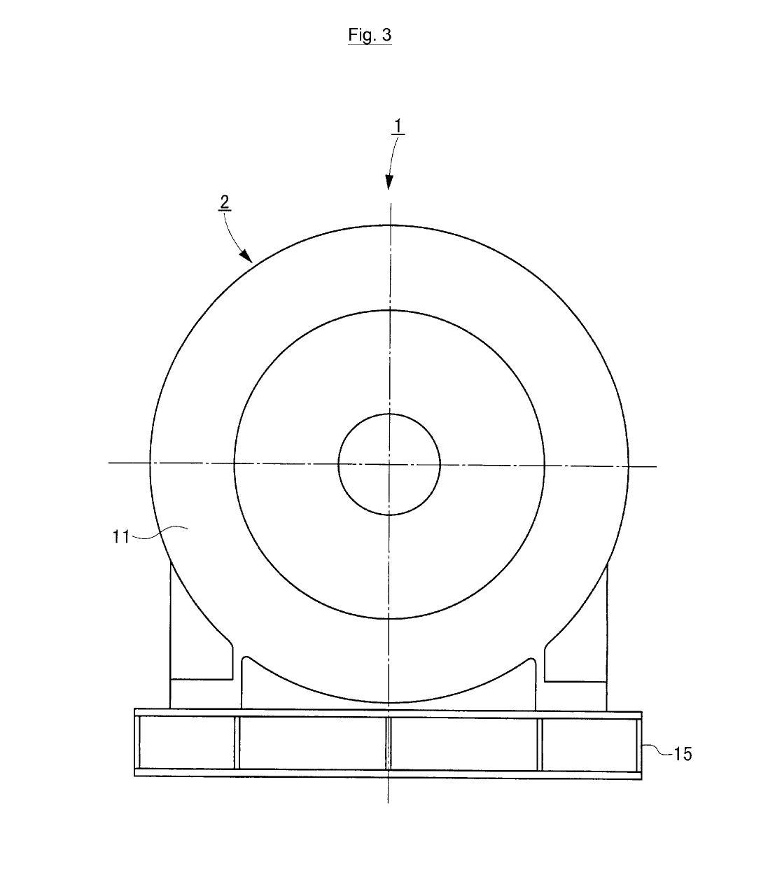

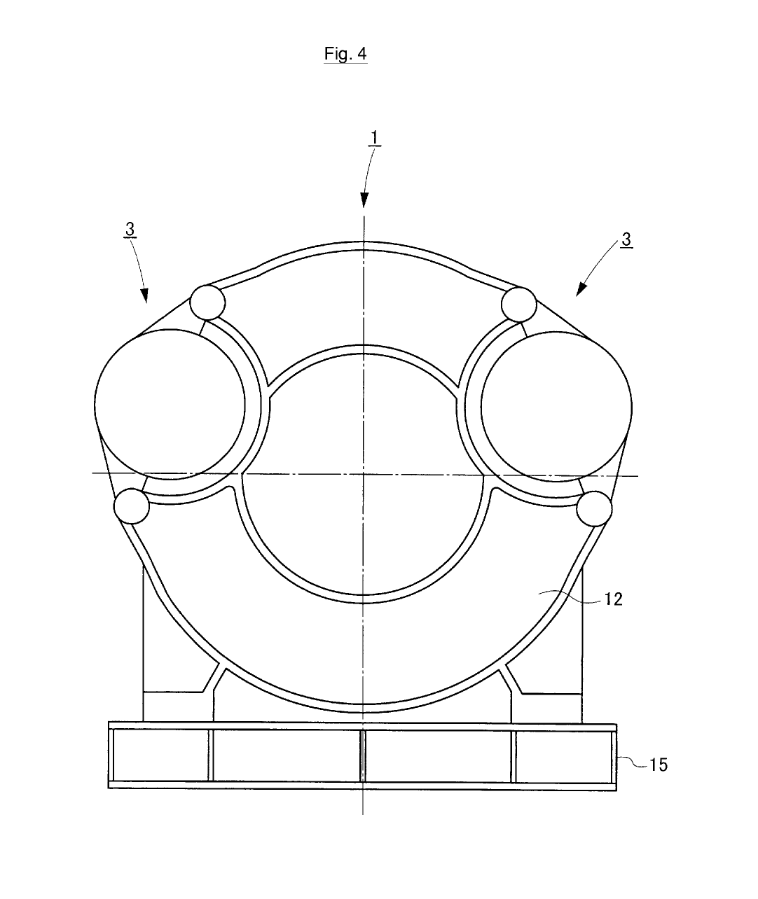

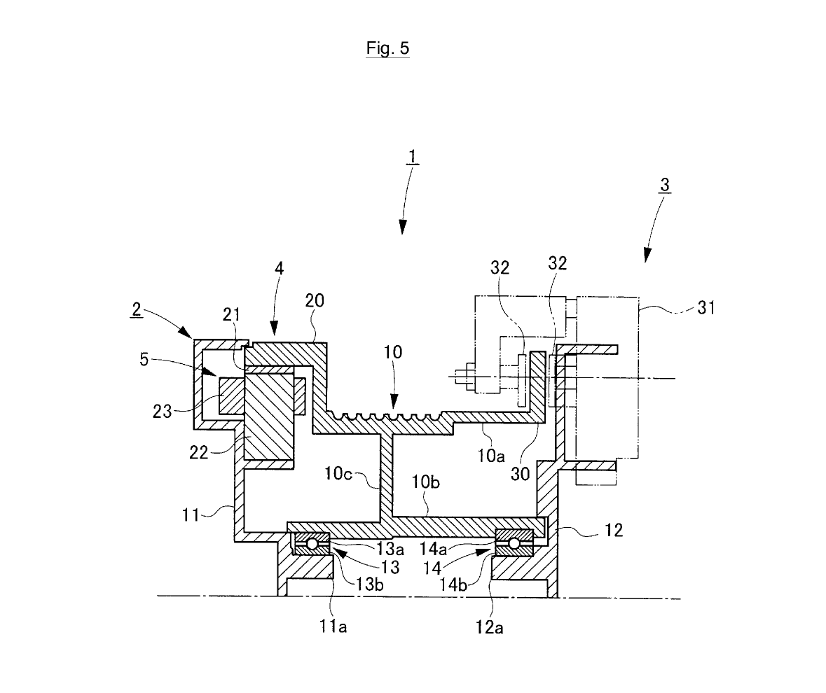

FIG. 1 is a sectional view of the hoist according to this embodiment. FIG. 2 is a side view of the hoist according to this embodiment. FIG. 3 is a front view of the hoist according to this embodiment. FIG. 4 is a rear view of the hoist according to this embodiment. FIG. 5 is a sectional view of another example of the hoist according to this embodiment. Note that the “left” and “right” in the following description are based on the left and right in FIGS. 1, 2, and 5.

As shown in FIGS. 1 to 4, in a hoist 1 according to this embodiment, a sheave 10 has a structure in which an outer cylinder 10a and an inner cylinder 10b are joined to each other with a connecting portion 10c. In a left stand 11A, a support portion 11a is formed to place the sheave 10 horizontally. In a right stand 12, a support portion 12a is formed to plate the sheave 10 horizontally.

A left bearing 13 is placed between the inner cylinder 10b of the sheave 10 and the support portion 11a of the left stand 11 and supports the sheave 10 such that the sheave 10 is rotatable. A right bearing 14 is placed between the inner cylinder 10b of the sheave 10 and the support portion 12a of the right stand 12 and supports the sheave 10 such that the sheave 10 is rotatable.

An outer race 13a of the left bearing 13 and an outer race 14a of the right bearing 14 are joined to an inner side of the inner cylinder 10b of the sheave 10. An inner race 13b of the left bearing 13 is joined to an outer side of the support portion 11a of the left stand 11. An inner race 14b of the right bearing 14 is joined to an outer side of the support portion 12a of the right stand 12.

The sheave 10 is placed between the left stand 11 and the right stand 12 as follows. First, the left stand 11 and the right stand 12 are temporarily secured to a bed 15. Then, the sheave 10 is placed between the left stand 11 and the right stand 12, and the distance and misalignment between the left stand 11 and the right stand 12 are corrected so as to center a rotation axis of the sheave 10. Last, the left stand 11 and the right stand 12 are secured to the bed 15.

A rotor core 20 is placed on an end portion of the sheave 10 on the left stand 11 side, and a magnet 21 is placed on an inner side of the rotor core 20. The rotor core 20 and the magnet 21 constitute a rotor 4, or the secondary, of a motor. A stator core 22 is placed in the left stand 11 at a position facing the magnet 21, and a field winding 23 is placed in the stator core 22. The stator core 22 and the field winding 23 constitute a stator 5, or the primary, of the motor. Then, the rotor 4 and the stator 5 constitute a motor part 2.

The rotor core 20 is configured as a separate member from the sheave 10 in this embodiment, but may be formed integrally with the sheave 10 as shown in FIG. 5.

A disk-shaped brake disk 30 is placed on an end portion of the sheave 10 on the right stand 12 side. In the right stand 12, a brake device 31 configured to brake rotation of the sheave 10 is placed. In FIGS. 1 and 5, the brake device 31 is shown with two-dot chain lines.

The brake device 31 includes friction portions 32, such as linings, which face the brake disk 30 and sandwich the brake disk 30 therebetween. The brake device 31 can stop the rotation of the sheave 10 by sandwiching the brake disk 30 with its friction portions 32. The brake disk 30 and the brake device 31 configure a brake part 3.

The brake disk 30 is configured as a separate member from the sheave 10 in this embodiment, but may be formed integrally with the sheave 10 as shown in FIG. 5.

Although a disk braking method is employed in this embodiment, other methods can be employed, such as a drum braking method for instance.

The motor part 2 and the brake part 3 are placed on the left side and on the right side, respectively, in this embodiment, but may be placed on the right side and on the left side, respectively, instead.

Above is the description of the configuration of the hoist 1 according to this embodiment.

Next, the operation of the hoist 1 according to this embodiment is described.

In the hoist 1 according to this embodiment, the sheave 10 is rotatably supported by the left stand 11 and the right stand 12. The left stand 11 and the right stand 12 are secured after the rotation axis of the sheave 10 is centered.

The rotor 4 rotates when the motor part 2 is driven with the friction portions 32 of the brake device 31 being out of contact with the brake disk 30, namely, in a brake opening state. Since the rotor 4 is joined to the sheave 10 which is joined to the brake disk 30, the rotor 4, the sheave 10, and the brake disk 30 rotate together. Accordingly, the rotation of the sheave 10 and the brake disk 30 can be controlled by controlling the rotation of the motor part 2.

Then, when pressure is applied by pushing the friction portions 32 of the brake device 31 against the brake disk 30, namely in a brake operating state, a brake torque is generated in the brake disk 30, and the rotating brake disk 30 slows down and stops. After stopping, the brake disk 30 keeps its stopped state.

When the brake is actuated after the brake disk 30 is stopped by control of the speed of the motor part 2, the brake disk 30 can keep its stopped state, as well. Then, since the rotor 4, the sheave 10, and the brake disk 30 are integral with each other, they can be rotated and stopped together.

Above is the description of the operation of the hoist 1 according to this embodiment.

As described above, the hoist 1 according to this embodiment is configured such that the rotor 4 and the brake disk 30 are directly attached to the sheave 10. Accordingly, a cantilever shaft is unnecessary, which can simplify the structure of the hoist 1.

Moreover, since the cantilever shaft which can be easily curved is unnecessary, the hoist 1 according to this embodiment is free from the problem of the curving of the cantilever shaft caused by a load on the shaft. In addition, using fewer components than the conventional hoist, the hoist 1 according to this embodiment can be reduced in size and weight.

Further, since the cantilever shaft which can be easily curved is unnecessary to make the hoist 1 according to this embodiment free from the problem of the curving of the cantilever shaft caused by a load on the shaft, a super large hoist can be manufactured.

In addition, since the hoist 1 according to this embodiment has a simple structure to be able to reduce its size and weight, cost reduction can be achieved.

Moreover, since the hoist 1 according to this embodiment can be reduced in size, space for installing an elevator can be reduced.

Thus, the hoist 1 according to this embodiment can provide a hoist having a simple configuration yet capable of supporting a heavy load.

### Embodiment 2

A second embodiment of the hoist according to the present invention is described below.

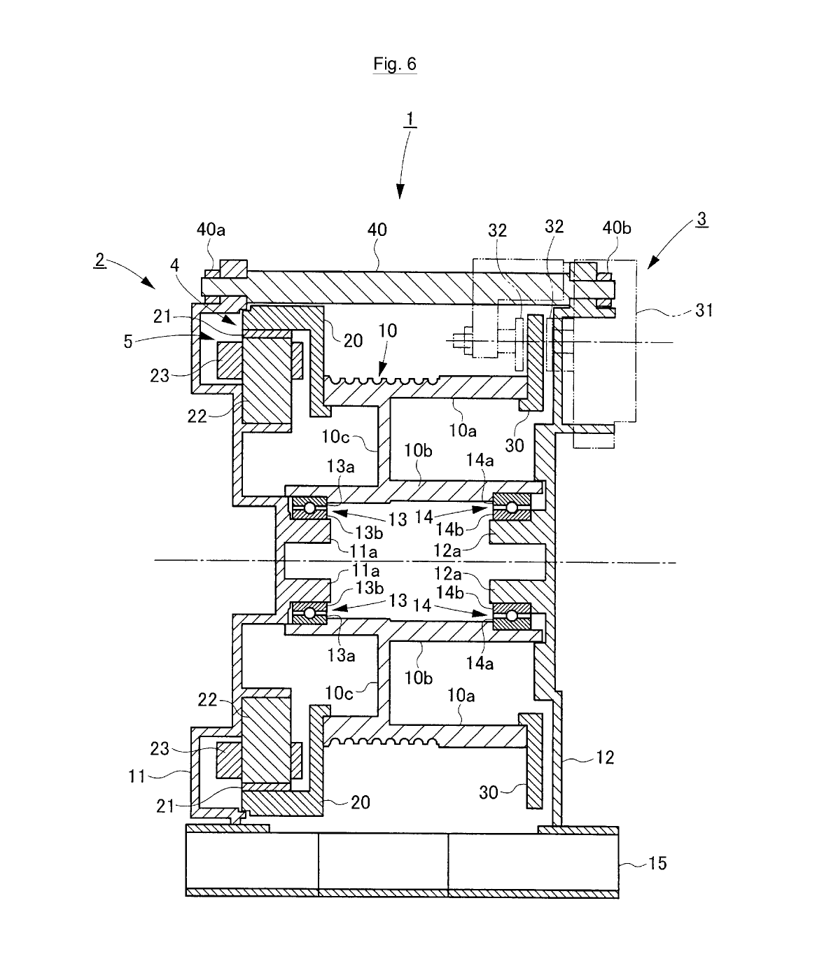

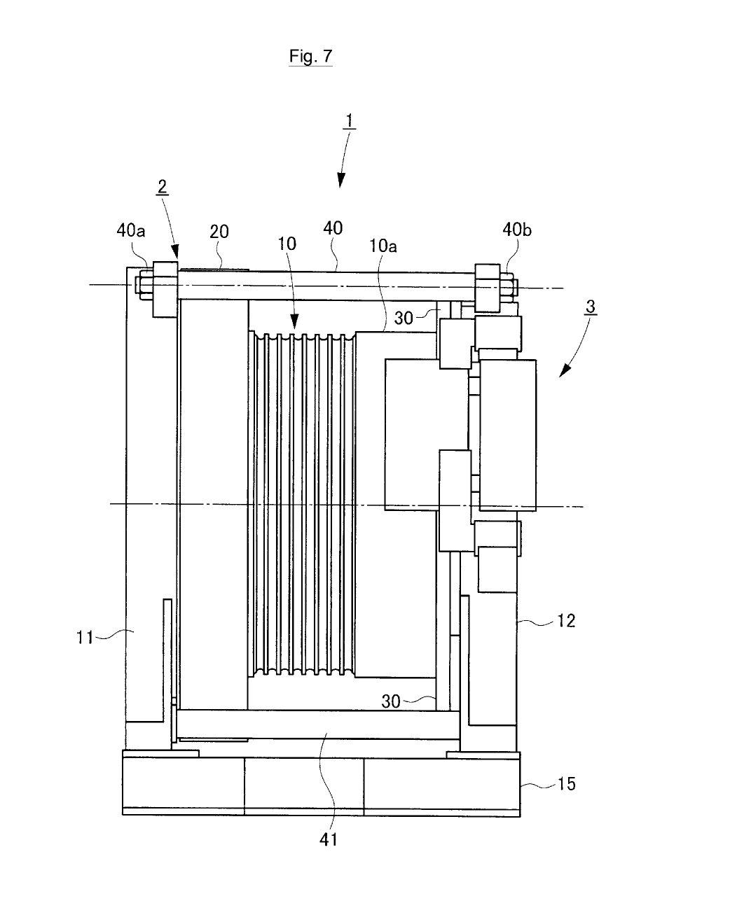

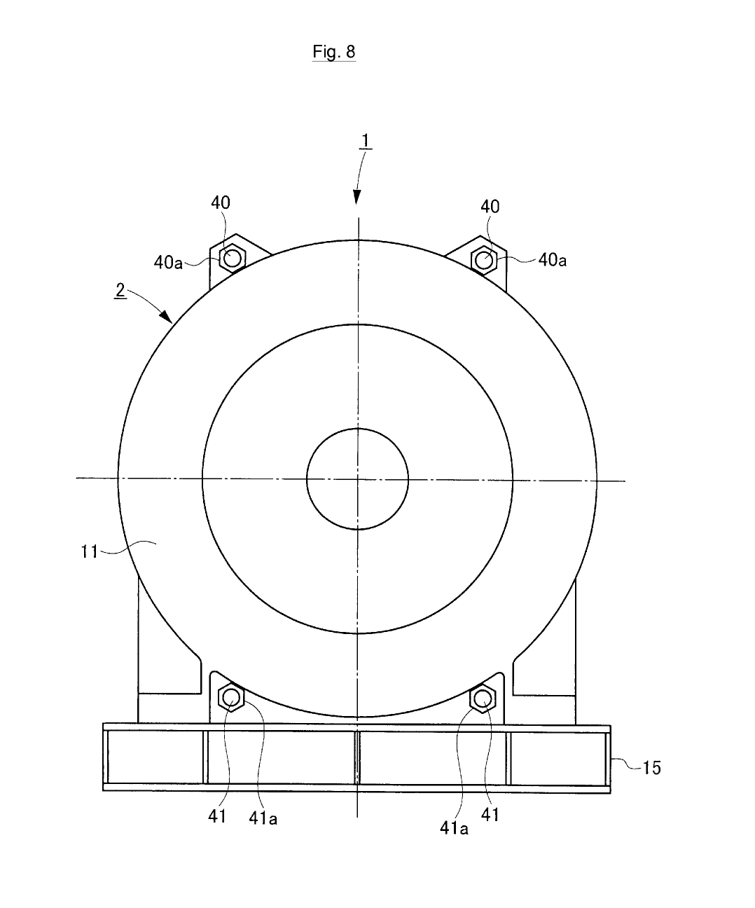

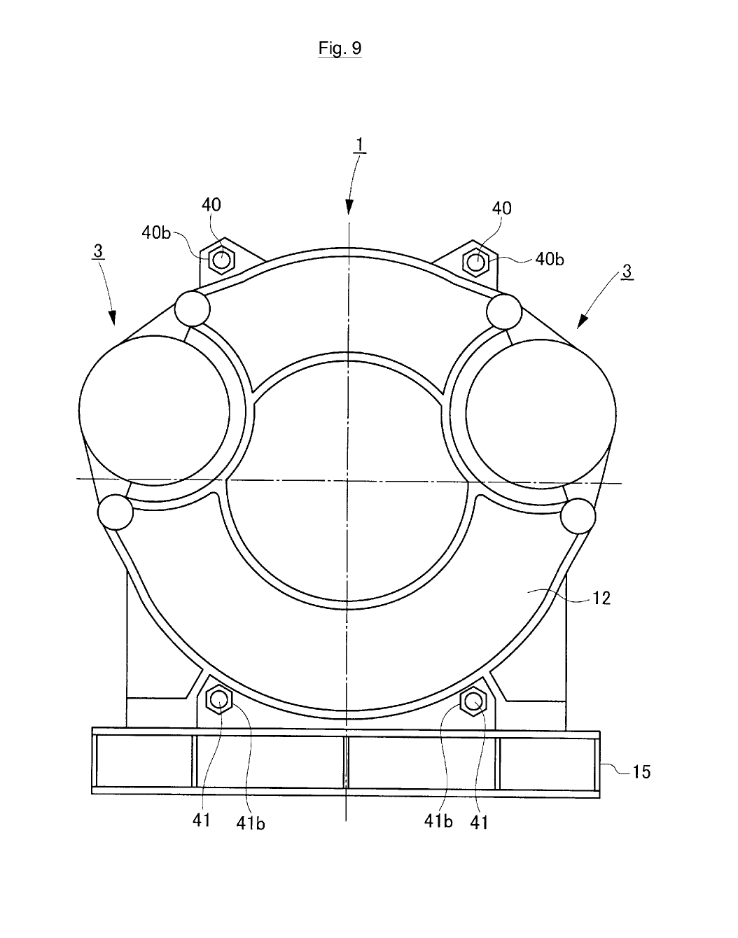

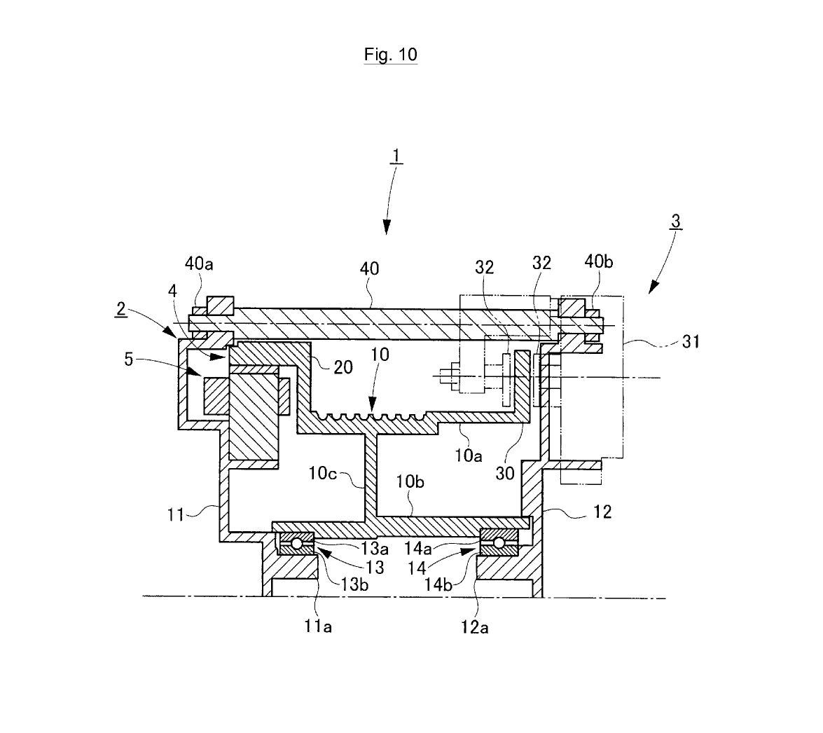

FIG. 6 is a sectional view of the hoist according to this embodiment. FIG. 7 is a side view of the hoist according to this embodiment. FIG. 8 is a front view of the hoist according to this embodiment. FIG. 9 is a rear view of the hoist according to this embodiment. FIG. 10 is a sectional view of another example of the hoist of this embodiment. Note that the “left” and “right” in the following description are based on the left and right in FIGS. 6, 7, and 10.

As shown in FIGS. 6 to 9, the configuration of the hoist 1 according to this embodiment is almost the same as that of the hoist 1 according to the first embodiment, but is different from it in including upper-portion maintaining members 40 and lower-portion maintaining members 41. The upper-portion maintaining members 40 are placed between an upper portion of the left stand 11 and an upper portion of the right stand 12 to maintain the gap between the left stand 11 and the right stand 12, and the lower-portion maintaining members 41 are placed between a lower portion of the left stand 11 and a lower portion of the right stand 12 to maintain the gap between the left stand 11 and the right stand 12.

Each upper-portion maintaining member 40 is secured to the left stand 11 by a nut 40a, and to the right stand 12 by a nut 40b. Each lower-portion maintaining member 41 is secured to the left stand 11 by a nut 41a, and to the right stand 12 by a nut 41b.

Accordingly, in the hoist 1 according to this embodiment, when the hoist 1 is assembled, the gap between the left stand 11 and the right stand 12 is automatically determined by the upper-portion maintaining members 40 and the lower-portion maintaining members 41 which are additionally provided. Accordingly, the centering of the rotation axis of the sheave 10 can be omitted.

The rotor core 20 is configured as a separate member from the sheave 10 in this embodiment, but may be formed integrally with the sheave 10 as shown in FIG. 10.

In addition, the brake disk 30 is configured as a separate member from the sheave 10 in this embodiment, but may be formed integrally with the sheave 10 as shown in FIG. 10.

As described above, in addition to the effects offered by the hoist according to the first embodiment, the hoist 1 according to this embodiment allows omission of the troublesome work of centering the rotation axis of the sheave 10 because the rotation axis of the sheave 10 can be centered automatically at the time of assembly of the hoist 1.

### Embodiment 3

A third embodiment of the hoist according to the present invention is described below.

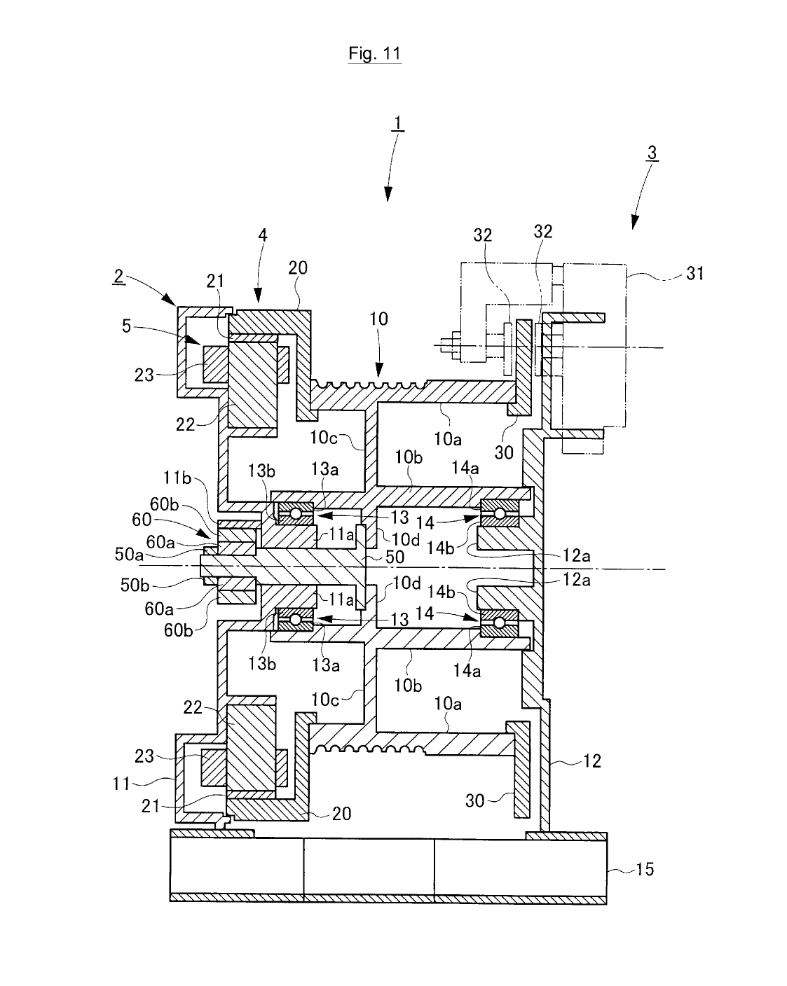

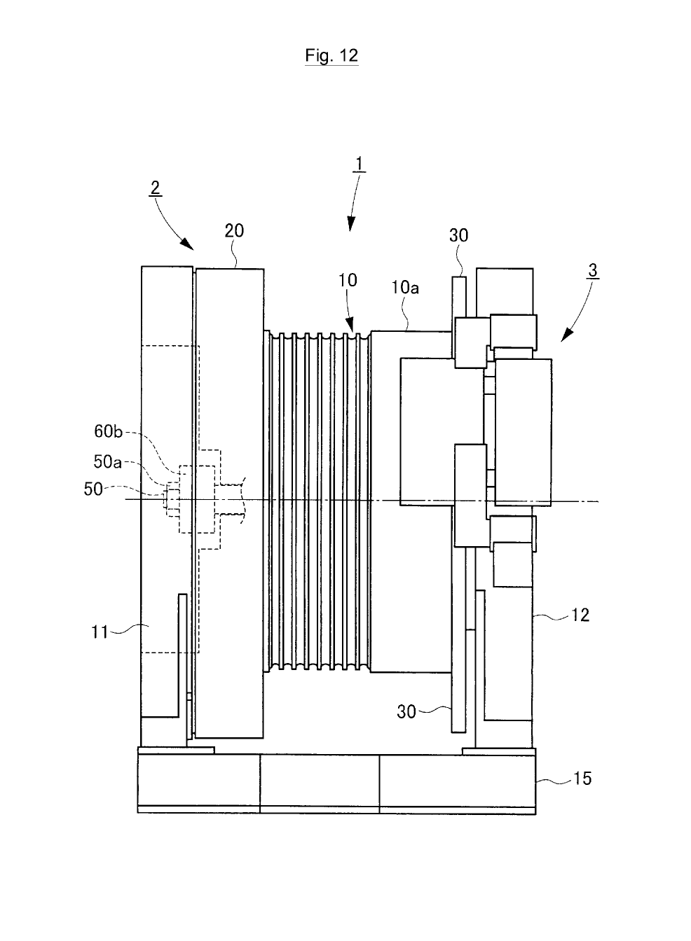

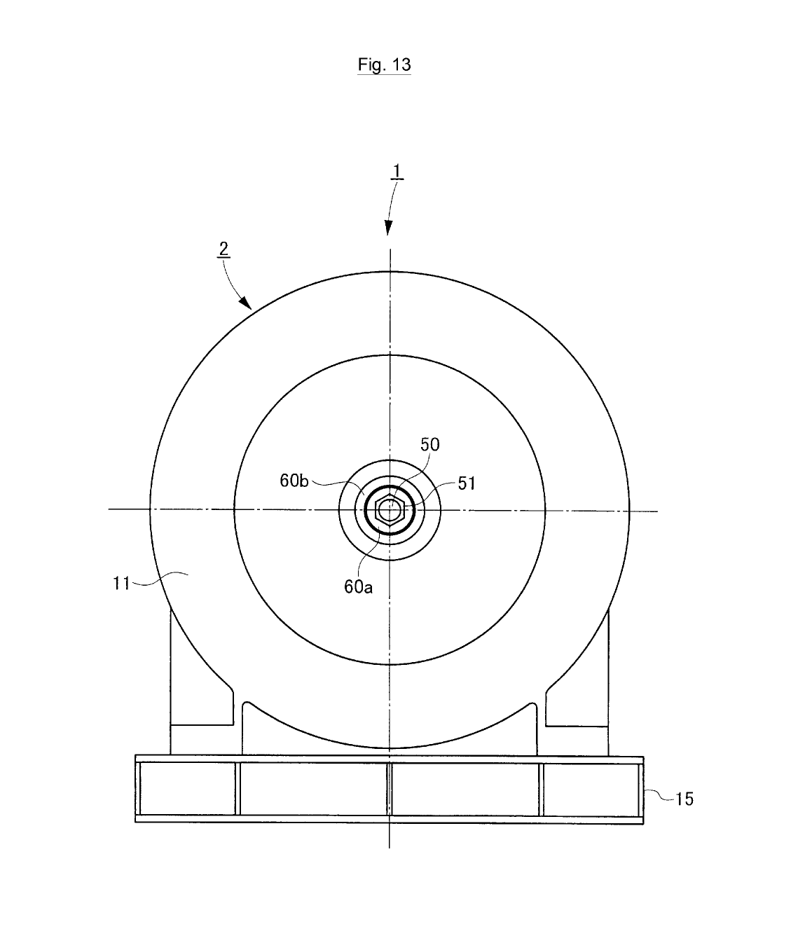

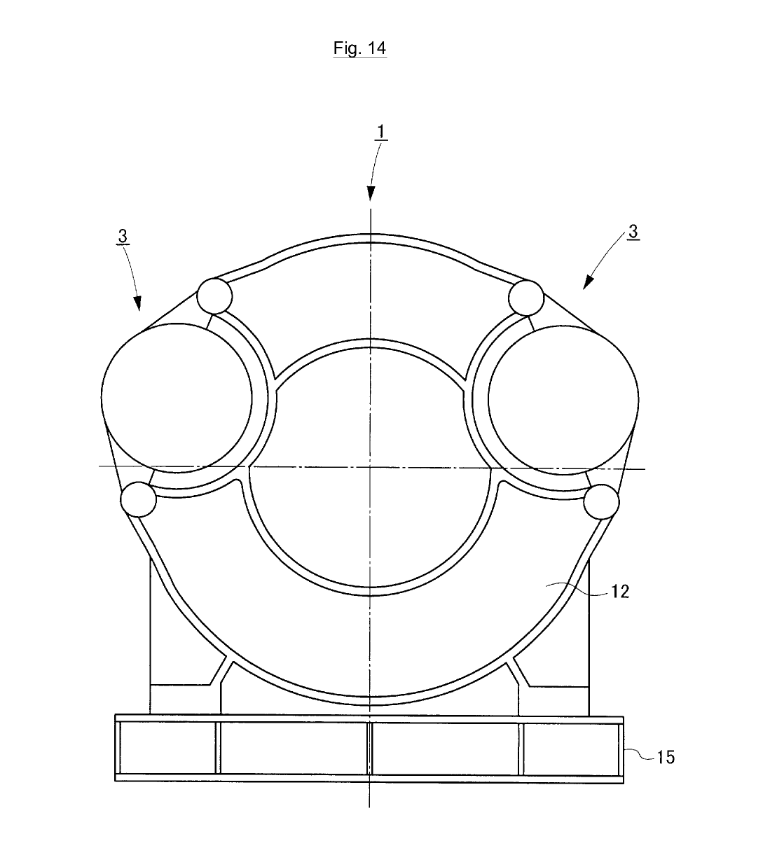

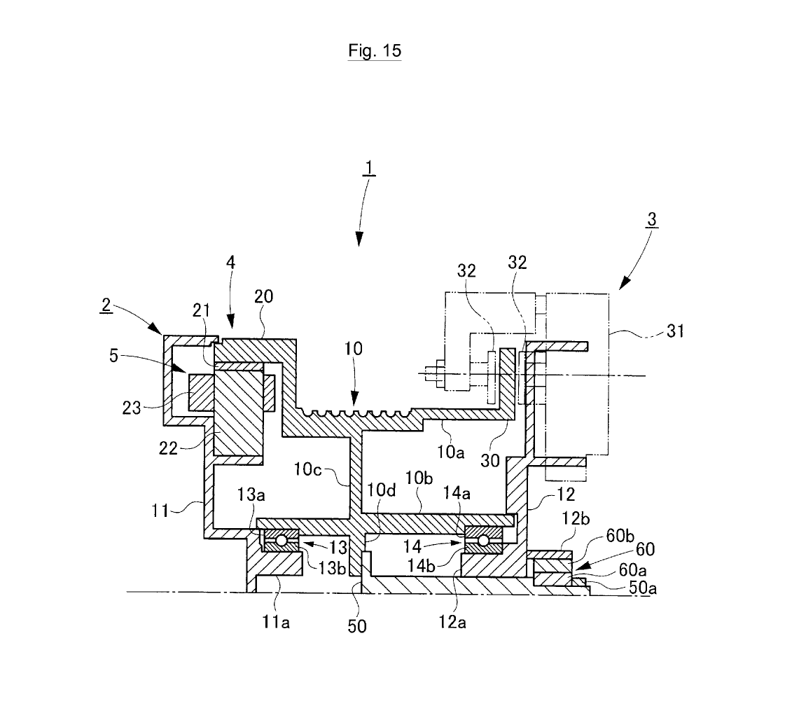

FIG. 11 is a sectional view of the hoist according to this embodiment. FIG. 12 is a side view of the hoist according to this embodiment. FIG. 13 is a front view of the hoist according to this embodiment. FIG. 14 is a rear view of the hoist according to this embodiment. FIG. 15 is a sectional view of another example of the hoist according to this embodiment. Note that the “left” and “right” in the following description are based on the left and right in FIGS. 11, 12, and 15.

As shown in FIGS. 11 to 14, the configuration of the hoist 1 according to this embodiment is almost the same as that of the hoist 1 according to the first embodiment, but is different from it in having a raised portion 10d on the inner side of the inner cylinder 10b of the sheave 10 and in including a rotation detection shaft 50 placed on this raised portion 10d and a rotation detector 60 placed on the rotation detection shaft 50.

The rotation detector 60 is configured by an inner rotary part 60a and an outer stationary part 60b. The rotary part 60a of the rotation detector 60 is fixed to the rotation detection shaft 50 by a nut 50a. The stationary part 60b of the rotation detector 60 is fixed to the left stand 11 by a fixing member 11b.

Accordingly, in the hoist 1 according to this embodiment, the rotation detection shaft 50 placed on the raised portion 10d of the inner side of the inner cylinder 10b of the sheave 10 rotates along with the sheave 10. Then, being attached between the rotation detection shaft 50 and the left stand 11, the rotation detector 60 rotates along with the sheave 10 and thus can detect the rotation of the motor part 2 coming to a stop.

The rotor core 20 is configured as a separate member from the sheave 10 in this embodiment, but may be formed integrally with the sheave 10 as shown in FIG. 15.

In addition, the brake disk 30 is configured as a separate member from the sheave 10 in this embodiment, but may be formed integrally with the sheave 10 as shown in FIG. 15.

Further, although the rotation detector 60 is located on the left in this example, the rotation detector 60 can instead be located on the right side as shown in FIG. 15. In which case, the stationary portion 60b of the rotation detector 60 is fixed to the right stand 12 by a fixing member 12b.

The configuration of the hoist 1 according to this embodiment can also be applied to the hoist 1 according to the second embodiment.

As described, in addition to the effects offered by the hoist 1 according to the first embodiment, the hoist 1 according to this embodiment offers the following effect. Specifically, when the hoist 1 employs an outer-rotor motor, generally, it is difficult to take out the rotation detection shaft 50, and therefore the rotation detector 60 is attached with a complicated structure. However, according to this embodiment, although the hoist 1 employs an outer-rotor motor, the rotation detector 60 can be attached with a simple structure.

### INDUSTRIAL APPLICABILITY

For example, the present invention can be applied to a hoist used for an elevator or the like.

### EXPLANATION OF REFERENCE NUMERALS

1 hoist
2 motor part
3 brake part
4 rotor
5 stator
10 sheave
10a outer cylinder
10b inner cylinder
10c connecting portion
10d raised portion
11 left stand
11a support portion
11b fixing member
12 right stand
12a support portion
12b fixing member
13 left bearing
13a outer race
13b inner race
14 right bearing
14a outer race
14b inner race
15 bed
20 rotor core
21 magnet
22 stator core
23 field winding
30 brake disk
31 brake device
32 friction portion
40 upper-portion maintaining member
40a, 40b nut
41 lower-portion maintaining member
41a, 41b nut
50 rotation detection shaft
50a nut
60 rotation detector
60a rotary part
60b stationary part

1. A hoist characterized in that the hoist comprises:
a sheave;
first supporting means and second supporting means for supporting the sheave at both ends of the sheave in an axial direction thereof, respectively, such that the sheave is rotatable;
a rotor placed on the end portion of the sheave on the first supporting means side;
a stator placed at a position facing an inner side of the rotor;
a brake disk placed on the end portion of the sheave on the second supporting means side coaxially with the sheave; and
braking means for providing braking by applying a pressure to the brake disk, the braking means being placed on the second supporting means.

2. The hoist according to claim 1, characterized in that the hoist further comprises, between the first supporting means and the second supporting means, maintaining means for maintaining a gap between the first supporting means and the second supporting means.

3. The hoist according to claim 1, characterized in that the hoist further comprises:
a rotation detection shaft placed at an axial end of the sheave and penetrating the first supporting means; and
rotation detecting means placed on the rotation detection shaft.
